(19) United States
(12) Patent Application Publication
(10) Pub. No.: US 2018/0219267 A1
(43) Pub. Date: Aug. 2, 2018

(54) HIGH-EFFICIENCY HYDROGEN-POWERED MOTOR VEHICLE

(71) Applicant: FORD GLOBAL TECHNOLOGIES, LLC, Dearborn, MI (US)

(72) Inventors: Douglas Raymond Martin, Canton, MI (US); John Eric Rollinger, Troy, MI (US); Kenneth James Miller, Canton, MI (US); Aed M. Dudar, Canton, MI (US)

(21) Appl. No.: 15/417,731

(22) Filed: Jan. 27, 2017

(51) Int. Cl. H01M 16/00; H01M 8/0656; H01M 8/04858

(52) U.S. Cl. CPC H01M 16/006; H01M 8/0656; H01M 8/04858; H01M 2250/20; B60Y 2400/434; B60Y 2400/202; B60Y 2300/18125

(57) ABSTRACT

A motor vehicle includes an electrolysis device for decomposing water into hydrogen and oxygen, a storage battery, a hydrogen-powered energy source providing motive power for the motor vehicle and a controller configured to prioritize routing excess vehicular-generated electrical energy to the electrolysis device over the storage batter. A related method of efficiently operating a hydrogen-powered motor vehicle is also disclosed.

### TECHNICAL FIELD

This document relates generally to the motor vehicle field and, more particularly, to a hydrogen-powered motor vehicle characterized by highly efficient operation and enhanced range of travel.

### BACKGROUND

Hydrogen-powered motor vehicles utilize hydrogen as the on-board fuel for motive power. The power plants for hydrogen-powered motor vehicles convert the chemical energy of hydrogen into mechanical or electrical energy and generally fall into one of two categories. The first category includes hydrogen internal combustion engines (H2ICE) which burn hydrogen in the combustion chamber to create mechanical energy to propel the vehicle. The second includes fuel cells which react hydrogen with oxygen to produce electricity for running an electric traction motor to propel the motor vehicle.

Today's hydrogen-powered motor vehicles suffer from some limitations that limit their appeal to a typical motor vehicle operator. In order to provide the hydrogen-powered motor vehicle with an acceptable driving range, the quantity of hydrogen needed requires a very large tank that takes up a great deal of space thereby reducing the size the of the trunk and/or passenger compartment of the motor vehicle. Further, even when a fairly large tank is provided, the vehicle has a range that is only marginally acceptable to today's customers.

While hydrogen may be made from water using an on-board electrolysis device, the operator of the motor vehicle typically does not want to be inconvenienced by the need to frequently add water to a storage tank. Some efforts have been made in the past to improve the range, efficiency and transient response of fuel cell powered vehicles by including a high voltage battery. That battery is charged when (a) the fuel cell produces excess electrical power, (b) the H2ICE produces excess mechanical power that is converted via the electric motor to electrical power and (c) the brake system uses the electric motor to resist the wheel motion to cause regenerative braking power that is sent to the battery. Disadvantageously, such a high voltage battery represents a significant capital cost, consumes a substantial amount of space on the motor vehicle and adds substantial weight reducing the performance of the motor vehicle.

This document relates to a new and improved hydrogen-powered motor vehicle that incorporates both an electrolysis device for decomposing water into hydrogen and oxygen, a water reclamation/recovery system, and a control method that synergizes the operation of the electrolysis device, the fuel cell/H2ICE, and the water reclamation/recovery system to improve the vehicle range and therefore enabling a downsized storage battery that is typically used to store energy and improve transient response. The new and improved hydrogen-powered motor vehicle also includes a controller configured to prioritize routing of excess vehicular-generated electrical energy to the electrolysis device over the storage battery. For purposes of this document, “excess vehicular-generated electrical energy” includes any electrical energy generated by any system of the motor vehicle in excess of that required for motor vehicle system or subsystem operation at any given moment in time. Furthermore, the controller may intentionally command the “excess vehicular-generated electrical energy” based on the purpose of increasing efficiency of the power source, or for increasing the supply of hydrogen, or for reducing the rate of change of desired powertrain power.

### SUMMARY

In accordance with the purposes and benefits described herein, a new and improved motor vehicle is provided. That motor vehicle comprises an electrolysis device decomposing water into hydrogen and oxygen, a storage battery, a hydrogen-powered energy source providing motive power for the motor vehicle and a controller configured to prioritize routing excess vehicular-generated electrical energy to the electrolysis device over the storage battery.

The motor vehicle may also include a water collection system having at least one vehicular water source and at least one water reservoir. That vehicular water source may be an air conditioning system component of the motor vehicle. Such an air conditioning system component includes, but is not necessarily limited to, a condenser and/or an evaporator. The water source may also be from the byproduct of the fuel cell operation, or the exhaust of the H2ICE. The water source may be a rainwater collector on the motor vehicle.

The motor vehicle may also include a regenerative braking system. Where the motor vehicle includes a regenerative braking system, the controller may be configured to prioritize routing excess vehicular-generated electrical energy from the regenerative braking system to the electrolysis device over the storage battery. The purpose may include to avoid overfilling the battery and to avoid the battery efficiency losses of charging and in the future discharging the battery energy.

The hydrogen-powered energy source that provides motive power for the motor vehicle may be a hydrogen internal combustion engine. In a motor vehicle incorporating a hydrogen internal combustion engine, the water source may be water vapor in the exhaust gases discharged from the hydrogen powered internal combustion engine.

The hydrogen-powered energy source of the motor vehicle may be a fuel cell. In a motor vehicle incorporating a fuel cell, the water source may be the fuel cell where hydrogen is reacted with oxygen to produce electrical energy and water. In such a motor vehicle, the controller may be configured to prioritize the routing of the excess vehicular-generated electrical energy from the fuel cell exceeding driver power demands at any given particular time to the electrolysis device over the storage battery.

The motor vehicle may also include a solar cell, which for purposes of this document includes an individual solar cell or an array of solar cells, which may provide excess vehicle generated electrical energy. In such a motor vehicle, the controller may be configured to prioritize routing of any excess vehicular-generated electrical energy from the solar cell to the electrolysis device over the storage battery.

In accordance with an additional aspect, a method is provided of efficiently operating a hydrogen-powered motor vehicle. That method comprises the steps of: (a) collecting water, by water collection system, (b) generating hydrogen from the water by electrolysis device and (c) prioritizing, by controller, routing of excess vehicular-generated electrical energy to the electrolysis device over a storage battery of the motor vehicle.

The method may include the step of generating a portion of the excess vehicular-generated electrical energy by a regenerative braking system. The method may include the step of generating a portion of the excess vehicular-generated electrical energy by solar cell.

The method may include operating a fuel cell of the motor vehicle at peak efficiency and generating a portion of the excess vehicular-generated electrical energy from the fuel cell exceeding driver power demands at any particular time. Additionally, the method may include generating a portion of the excess vehicular-generated electrical energy when a fuel cell of the motor vehicle transitions from a period of high driver power demand to a period of low driver power demand by reducing the fuel cell power at a slower rate than the driver demand rate.

The method may include the step of collecting water from the exhaust of a hydrogen power source of the motor vehicle. The method may include collecting water from an air conditioning system component of the motor vehicle. The method may include the step of collecting rainwater from a from a rainwater collector carried on the motor vehicle.

In the following description, there are shown and described several preferred embodiments of the new and improved motor vehicle as well as the related method of increasing the range of the vehicle by opportunistically and efficiently operating the hydrogen-powered motor vehicle. As it should be realized, the motor vehicle and method are capable of other, different embodiments and their several details are capable of modification in various, obvious aspects all without departing from the motor vehicle and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the motor vehicle and method and together with the description serve to explain certain principles thereof.

FIG. 1 is a schematic block diagram of the new and improved motor vehicle.

FIG. 2 is a schematic block diagram of the controller of the motive power system shown in FIG. 1.

FIG. 3 is a control logic flow diagram for the motive power system of the motor vehicle.

Reference will now be made in detail to the present preferred embodiments of the motor vehicle and related method, examples of which are illustrated in the accompanying drawing figures.

### DETAILED DESCRIPTION

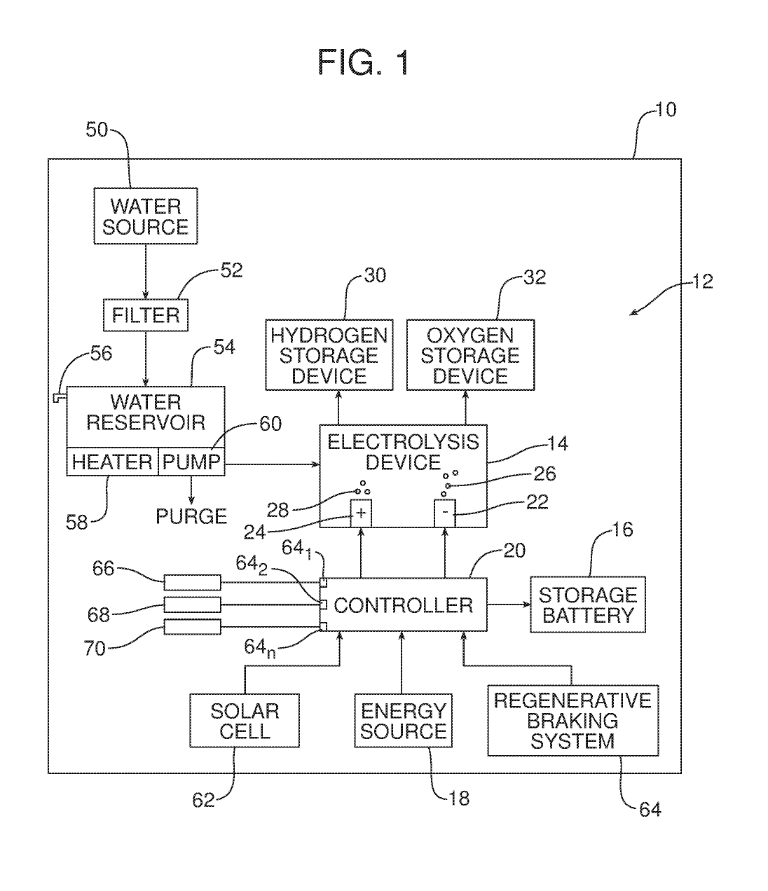

Reference is now made to FIG. 1, which schematically illustrates the new and improved motor vehicle 10 which is characterized by enhanced operating efficiency and range as well as increased passenger cabin and cargo space. As illustrated, the motor vehicle 10 includes an advanced motive power system 12. That motive power system 12 includes an electrolysis device 14, a storage battery 16, a hydrogen-powered energy source 18 and a controller 20. More specifically, the electrolysis device 14 functions to decompose water into hydrogen and oxygen. Toward this end, the electrolysis device includes an anode 22 and a cathode 24. When an electric current is supplied to the electrolysis device 14, oxygen bubbles 26 are generated from the water at the anode 22 and hydrogen bubbles 28 are generated from the water at the cathode 24. The generated hydrogen is stored on board the motor vehicle 10 in a hydrogen storage device 30 which may be either a chemical or compressed gas storage device of a type known in the art. If desired, the oxygen may also be stored on board the motor vehicle in an oxygen storage device 32 of a type known in the art or simply exhausted to the ambient environment. The hydrogen-powered energy source 18 may comprise a fuel cell or a hydrogen internal combustion engine, either of which may provide the motive power for the motor vehicle 10.

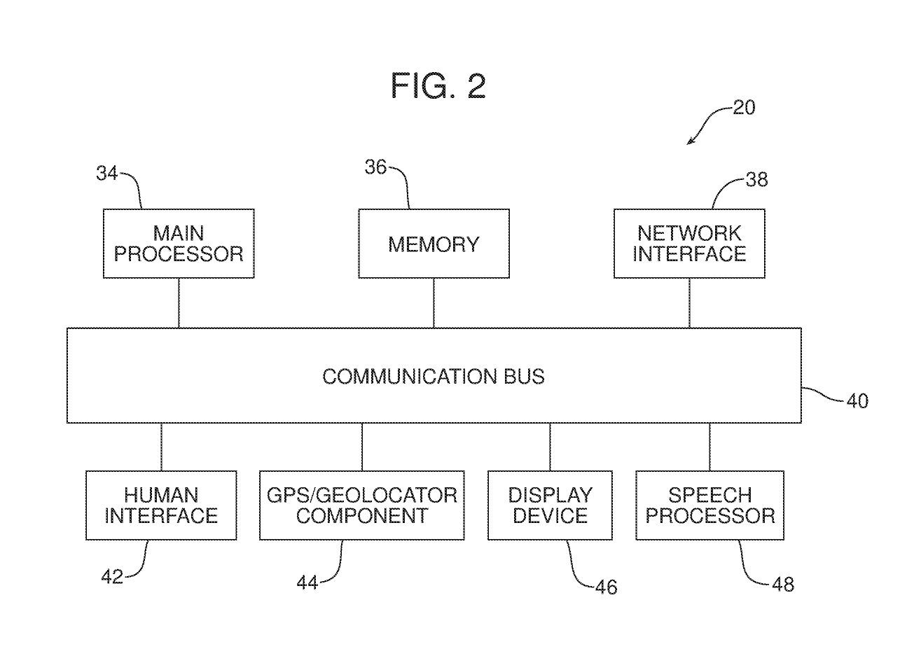

The controller 20 may comprise a computing device such as a dedicated microprocessor or electronic control unit (ECU) operating in accordance with instructions from appropriate control software. As illustrated in FIG. 2, the controller 20 may comprise one or more processors 34, one or more memories 36 and one or more network interfaces 38. As should be appreciated, all of these components 34, 36, 38 communicate with each other over a communication bus 40.

In the embodiment illustrated in FIG. 2, the controller 20 is a body control module or BCM that also incorporates a human interface 42, a GPS geolocator component 44, a display device 46 and a speech processor 48 that also communicate over the communication bus 40. In such an embodiment, the display device 46 may comprise a multi-function display with touchscreen capability.

The BCM controller 20 performs a number of interior body electrically based functions including, for example, interior locking, remote key entry, interior lighting, exterior lighting, windshield wiper control and the like. In some embodiments, the BCM may also function to control entertainment functions (e.g. radio, CD player and communications such as telephone and Internet communication over a wireless network). In some embodiments the BCM is connected by a communication bus (not shown) to other control modules that provide one or more of these additional functions.

Water for the electrolysis device 14 and the generation of hydrogen fuel for the hydrogen-powered energy source 18 may be provided from a water source 50 on board the motor vehicle 10. The water source 50 may comprise an air conditioning system component of the motor vehicle such as a condenser and/or evaporator.

The water source 50 may also comprise a rainwater collector on the motor vehicle. For example, the rainwater collector may comprise (a) door seal area channels which provide gravity flow for rainwater to a collection tray, (b) a rainwater collection tray under the open cowl of the motor vehicle and/or other appropriate structure.

The water source 50 may also comprise water vapor in exhaust gases where the hydrogen-powered energy source is a hydrogen internal combustion engine. Alternatively, those exhaust gases may comprise the water vapor produced in the fuel cell where the hydrogen-powered energy source 18 is a fuel cell.

The water source 50 may also comprise the air intake system of the motor vehicle. More specifically, cold parts or components of the air intake system collect condensation that may be collected.

Water from the water source 50 is routed through a filter 52 and is stored in a water reservoir 54 which may include an overflow 56 and a heater 58 to prevent the water in the water reservoir from freezing. A pump 60 in the bottom of the reservoir may be used to (a) purge the reservoir when freezing of the water in the reservoir is imminent or (b) pump the water from the reservoir to the electrolysis device 14 for the generation of hydrogen fuel.

Excess vehicular-generated electrical energy for powering the electrolysis device 14 and generating hydrogen fuel may be provided by a number of sources on board the motor vehicle 10. In the embodiment illustrated in FIG. 1, the motor vehicle 10 includes a solar cell 62, which may take the form of a solar cell array or solar panel on the roof or other exposed surface of the motor vehicle. The solar cell 62 generates free electrical energy when parked or driving outdoors and exposed to sunlight. The motor vehicle 10 may also include a regenerative braking system 64 of a type known in the art for generating electrical energy while slowing the motor vehicle 10.

The controller 20 is configured to prioritize routing the excess vehicular-generated electrical energy to the electrolysis device 14 over the storage battery 16. This includes the excess vehicular-generated electrical energy from the solar cell 62 and the regenerative braking system 64. It also includes any excess vehicular-generated electrical energy from the hydrogen-powered energy source 18. In some possible embodiments, the controller 20 may be configured so that only when the excess vehicular-generated electrical energy exceeds that required by the electrolysis device 14 is any excess vehicular-generated electrical energy routed by the controller to the storage battery 16. This increases the charge of the storage battery 16 and makes that energy available for transient response.

Consistent with the above description, a method is provided for more efficiently operating a hydrogen-powered motor vehicle 10. That method comprises collecting water by on board water collection system 66 including the water source 50, the filter 52, the water reservoir 54, the overflow 56, the water heater 58 and the pump 60. In addition, the method includes the step of generating hydrogen, by the electrolysis device 14, from the water displaced by the pump 60 to the electrolysis device from the water reservoir 54. Further, the method includes prioritizing, by the controller 20, routing of excess vehicular-generated electrical energy to the electrolysis device 14 for the generation of hydrogen fuel over the storage battery 16 for the storage of electrical energy.

More specifically, the method may include generating a portion of the excess vehicular-generated electrical energy by the regenerative braking system 64. The method may also include the step of generating a portion of the excess vehicular-generated electrical energy by the solar cell 62.

Further, the method may include operating a fuel cell hydrogen-powered energy source 18 of the motor vehicle 10 at peak efficiency and generating a portion of the excess vehicular-generated electrical energy when the fuel cell electrical energy output exceeds driver power demands at any particular time. Further, the method may include the step of generating a portion of the excess vehicular-generated electrical energy when the fuel cell hydrogen-powered energy source 18 of the motor vehicle 10 transitions from a period of high driver power demand to a period of low driver power demand.

As should also be appreciated, the method may include the step of collecting water from exhaust from a hydrogen power source 18 of the motor vehicle 10. The method may also include the step of collecting water from an air conditioning system component, such as a condenser and/or an evaporator of the motor vehicle 10. Further, the method may include the step of collecting rainwater from a rainwater collector carried on the motor vehicle 10.

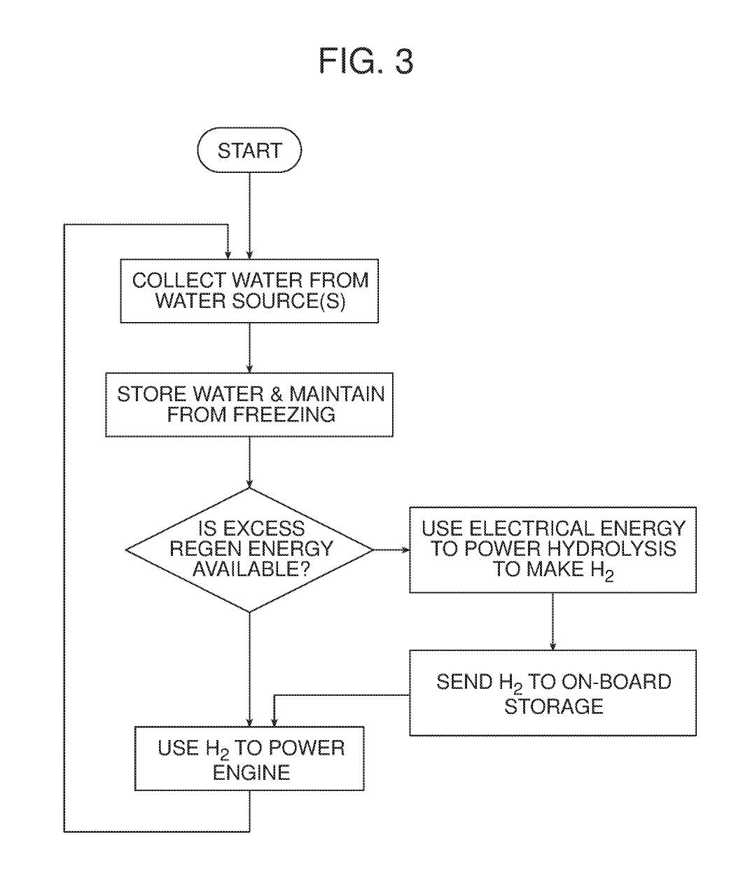

Reference is now made to FIG. 3, illustrating a control logic flow diagram illustrating one possible way for configuring the controller 20 and operating the hydrogen-powered motor vehicle 10 at higher efficiency. For purposes of this embodiment, the controller 20 may be configured to include multiple data inputs 68₁, 68₂, 68ₙ connected to various devices capable of providing data including, for example, a water level sensor 70, an ambient temperature sensor 72 and a vehicle speed indicator 74. The water level sensor 70 provides data respecting the level of water in the water reservoir 54 for supply to the electrolysis device 14 and the generation of hydrogen fuel. The ambient temperature sensor 72 and the vehicle speed indicator 74 provide data used by the controller 20 to operate a motor vehicle 10 equipped with a fuel cell hydrogen energy source 18 at peak efficiency.

The control logic flow diagram presented in FIG. 3 is self-explanatory.

In summary, the motor vehicle 10 provides a number of benefits and advantages. The motor vehicle 10 utilizes reclaimed water and reclaimed excess vehicular-generated electrical energy to make additional hydrogen fuel to extend the operating range of the motor vehicle by prioritizing the routing of that excess vehicular-generated electrical energy to the electrolysis device 14 over the storage battery 16. It is possible to also downsize the storage battery. The downsized storage battery may have the following specifications: 1.5 kilowatt-hour capacity Lithium-ion battery pack.

In contrast, a higher capacity storage battery on a state of the art hydrogen-powered vehicle typically has the following specifications: 2.2 kilowatt-hour capacity Lithium-ion battery pack.

The downsized storage battery 16 provides multiple benefits including smaller overall size for increased passenger and cargo space in the motor vehicle 10, increased freedom of vehicle design allowing enhanced functionality and aesthetic appeal and lower overall weight for better motor vehicle performance.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A motor vehicle, comprising:
an electrolysis device decomposing water into hydrogen and oxygen;
a storage battery;
a hydrogen powered energy source providing motive power for said motor vehicle; and
a controller configured to prioritize routing excess vehicular generated electrical energy to said electrolysis device over said storage battery.

2. The motor vehicle of claim 1, further including a water collection system including at least one vehicular water source and at least one water reservoir.

3. The motor vehicle of claim 2, wherein said at least one vehicular water source is an air conditioning system component of said motor vehicle.

4. The motor vehicle of claim 3, wherein said at least one vehicular water source is a rain water collector on said motor vehicle.

5. The motor vehicle of claim 4, further including a regenerative braking system.

6. The motor vehicle of claim 5, wherein said controller is configured to prioritize routing excess vehicular generated electrical energy from said regenerative braking system to said electrolysis device over said storage battery.

7. The motor vehicle of claim 6, wherein said hydrogen powered energy source is a hydrogen internal combustion engine.

8. The motor vehicle of claim 7, wherein said at least one vehicular water source is water vapor in exhaust gases of said motor vehicle.

9. The motor vehicle of claim 6, wherein said hydrogen powered energy source is a fuel cell.

10. The motor vehicle of claim 9, wherein said vehicular water source is said fuel cell.

11. The motor vehicle of claim 10, wherein said controller is configured to prioritize routing of excess vehicular generated electrical energy from said fuel cell exceeding driver power demands to said electrolysis device over said storage battery.

12. The motor vehicle of claim 1, further including a solar cell providing excess vehicular generated electrical energy.

13. A method of efficiently operating a hydrogen powered motor vehicle, comprising:
collecting water, by water collection system;
generating hydrogen from said water by electrolysis device; and
prioritizing, by controller, routing of excess vehicular generated electrical energy to said electrolysis device over a storage battery of said hydrogen powered motor vehicle.

14. The method of claim 13, including generating a portion of said excess vehicular generated electrical energy by regenerative braking system.

15. The method of claim 13, including generating a portion of said excess vehicular generated electrical energy by solar cell.

16. The method of claim 13, including operating a fuel cell or a H2ICE of said hydrogen powered motor vehicle at a greater efficiency and generating a portion of said excess vehicular generated electrical energy when fuel cell electrical energy output exceeds driver power demands.

17. The method of claim 13, including generating a portion of said excess vehicular generated electrical energy when a fuel cell of said hydrogen powered motor vehicle transitions from a period of high driver power demand to a period of low driver power demand.

18. The method of claim 13, including collecting water from exhaust from a hydrogen power source of said hydrogen powered motor vehicle.

19. The method of claim 13, including collecting water from an air conditioning system component of said hydrogen powered motor vehicle.

20. The method of claim 13, including collecting rainwater from a rainwater collector carried on said hydrogen powered motor vehicle.
